(19) United States
(12) Patent Application Publication
(10) Pub. No.: US 2025/0307499 A1
(43) Pub. Date: Oct. 2, 2025

(54) MITIGATION OF SUBSTRATE DEFORMATION IN DEVICE MANUFACTURING USING MACHINE LEARNING SYSTEMS AND TECHNIQUES

(71) Applicant: Applied Materials, Inc., Santa Clara, CA (US)

(72) Inventors: Wonjae Lee, Fremont, CA (US); Pradeep Kumar Subrahmanyan, San Jose, CA (US)

(21) Appl. No.: 19/076,347

(22) Filed: Mar. 11, 2025

Related U.S. Application Data
(60) Provisional application No. 63/570,186, filed on Mar. 26, 2024.

(51) Int. Cl. G06F 30/27; G06F 111/08; G06F 119/14

(52) U.S. Cl. CPC G06F 30/27; G06F 2111/08; G06F 2119/14

(57) ABSTRACT

Disclosed systems and techniques that deploy machine learning models (MLMs) for mitigation of stresses and deformations of substrates. The techniques include obtaining a training input that includes a map of deformation of a substrate, processing the training input using the MLM to generate an MLM output, the MLM output predicting a dose map for a stress-modification beam (SMB) that, being applied to a stress-compensation layer (SCL) formed on the substrate, causes modification of the deformation of the substrate. The techniques further include training the MLM using the predicted dose map and deploying the trained MLM for processing of one or more additional substrates.

### RELATED APPLICATIONS

The present application claims the benefit under 35 U.S.C. § 119 (e) of U.S. Provisional Patent Application No. 63/570,186 filed Mar. 26, 2024, entitled “MITIGATION OF SUBSTRATE DEFORMATION IN DEVICE MANUFACTURING USING MACHINE LEARNING SYSTEMS AND TECHNIQUES,” the contents of which are being incorporated in their entirety by reference herein.

### TECHNICAL FIELD

The disclosure pertains to semiconductor manufacturing, including processing of wafers and devices manufactured thereon.

### BACKGROUND

Modern semiconducting devices, such as processing units, memory devices, light detectors, solar cells, light-emitting semiconductor devices, devices that deploy complementary metal-oxide-semiconductor (CMOS) structures, and the like, are often manufactured on silicon wafers (or other suitable substrates). Wafers can undergo numerous processing operations, such as physical vapor deposition, chemical vapor deposition, etching, photo-masking, polishing, and/or various other operations. In a continuous effort to reduce the cost of semiconductor devices, multi-layer stacks of dies, insulating films, patterned and/or doped semiconducting films, and/or other features are often deposited on a single wafer, resulting in high aspect ratio devices, which are used, e.g., in 3D flash memory devices and other applications. Deposition, patterning, etching, polishing, etc., of stacks of multi-layered structures often result in significant stresses applied to the underlying wafers. Such stresses lead to both an out-of-plane distortion and an in-plane distortion of features supported by the wafers. These distortions result in misalignment of deposited features and can significantly degrade quality of manufactured devices.

### SUMMARY

Disclosed herein, according to one embodiment, is a method of training a machine learning model (MLM), including generating a training input. The training input includes a representation of deformation of a substrate and processing the training input using the MLM to generate an MLM output. The MLM output includes a predicted dose map for a stress-modification beam (SMB) that, being applied to a stress-compensation layer (SCL) formed on the substrate, causes modification of the deformation of the substrate. The method further includes modifying the MLM using at least the predicted dose map and causing the trained MLM to be deployed for processing of one or more additional substrates.

In another embodiment, disclosed is a method that includes obtaining an input into an MLM, the input including a map of deformation of a substrate, and forming an SCL on the substrate. The method further includes processing, using the MLM, the obtained input to generate an MLM output. The MLM output includes a first dose map for an SMB. The method further includes subjecting the SCL to the SMB to cause modification of the deformation of the substrate. A dose map imparted to the SCL is based at least on the first dose map.

In another embodiment, disclosed is system that includes a memory and a processing device communicatively coupled to the memory. The processing device causes performance of operations that include obtaining a training input. The training input includes a map of deformation of a substrate. The operations further include processing the training input using an MLM to generate an MLM output. The MLM output includes a predicted dose map for an SMB that, being applied to an SCL formed on the substrate, causes modification of the deformation of the substrate. The operations further include modifying the MLM using at least the predicted dose map and causing the trained MLM to be deployed for processing of one or more additional substrates.

### BRIEF DESCRIPTION OF THE DRAWINGS

The present disclosure will be understood more fully from the detailed description given below and from the accompanying drawings of various embodiments of the disclosure.

FIG. 1A illustrates schematically a portion of a uniformly (e.g., parabolically) deformed wafer such that the stress tensor is isotropic σₓₓ≈σ_{yy}. FIG. 1B illustrates schematically a portion of a wafer having anisotropic (e.g., cylindrical) deformation such that the stress tensor is anisotropic σₓₓ>σ_{yy}. FIG. 1C illustrates an example Zernike polynomial decomposition that can be used to characterize deformation of a wafer.

FIGS. 2A-2E show a wafer-wide view of an example process of semiconductor manufacturing, according to at least one embodiment.

FIGS. 3A-F illustrate schematically a process of correcting wafer deformation using a stress-modification beam applied to a stress compensation layer deposited on a back side of a wafer and partially shielded by a directional pattern, according to at least one embodiment.

FIG. 4 illustrates an example computer architecture that deploys a stress-modification machine-learning model (MLM) to determine doses of particles (or photons) of a beam used for mitigation of stresses in wafers, according to at least one embodiment.

FIG. 5 illustrates an example data flow of training and deploying a stress-modification MLM to determine dose maps for mitigation of stresses in wafers, according to at least one embodiment.

FIG. 6 illustrates an example data flow of deploying a hybrid model, which includes a combination of a stress-modification MLM and a physics model, to determine dose maps for mitigation of stresses in wafers, according to at least one embodiment.

FIG. 7 is a flowchart illustrating an example method of using a machine learning model to facilitate mitigation of stresses in substrates, according to at least one embodiment.

FIG. 8 is a flowchart illustrating an example method of determining settings for beam irradiation, according to at least one embodiment.

FIGS. 9A-9B illustrates schematically an irradiation system capable of performing irradiation of stress compensation layers, according to at least one embodiment.

FIG. 10 is a flowchart illustrating an example method of training a machine learning model to facilitate mitigation of stresses in substrate in manufacturing of semiconductor devices and/or other applications, according to at least one embodiment.

FIG. 11 depicts a block diagram of an example computer system capable of supporting operations of the present disclosure, according to at least one embodiment.

### DETAILED DESCRIPTION

Modern technology often aims to maximize chip area utilization by manufacturing three-dimensional devices with vertical stacks of multiple layers of semiconducting structures. For example, in NAND flash memory devices, lateral relative arrangement (CMOS near Array, or CnA) of memory cells (e.g., floating gate transistors) and peripheral transistors (e.g., CMOS circuitry used to support write/read operations involving memory cells) has mostly given way to a vertical arrangement (CMOS under Array, or CuA) in which peripheral CMOS circuitry is disposed below an array of memory cells. In many instances, semiconductor structures are manufactured in an anisotropic fashion, e.g., with multiple high, long (along the direction of wordlines), and narrow (along the direction of bitlines) stacks of memory cells manufactured (deposited and/or etched) on wafers. Depositing these and other high aspect ratio structures typically results in complex stresses σⱼₖ(x, y) that can lead to a combination of isotropic (e.g., bow-like, parabolic) deformations and anisotropic (e.g., cylindric, saddle-shaped, etc.) deformations. Wafer deformation can lead to misalignment of manufactured features and result in substandard or inoperable devices. Correcting stresses and the resulting wafer deformations is an important but difficult task. In addition to stresses caused by directional features, various other sources of stresses can occur in wafers, e.g., stresses that appear in the course of manufacturing of dies, e.g., units of formed semiconducting devices, variations of the conditions in processing chamber(s) from wafer to wafer, and/or the like.

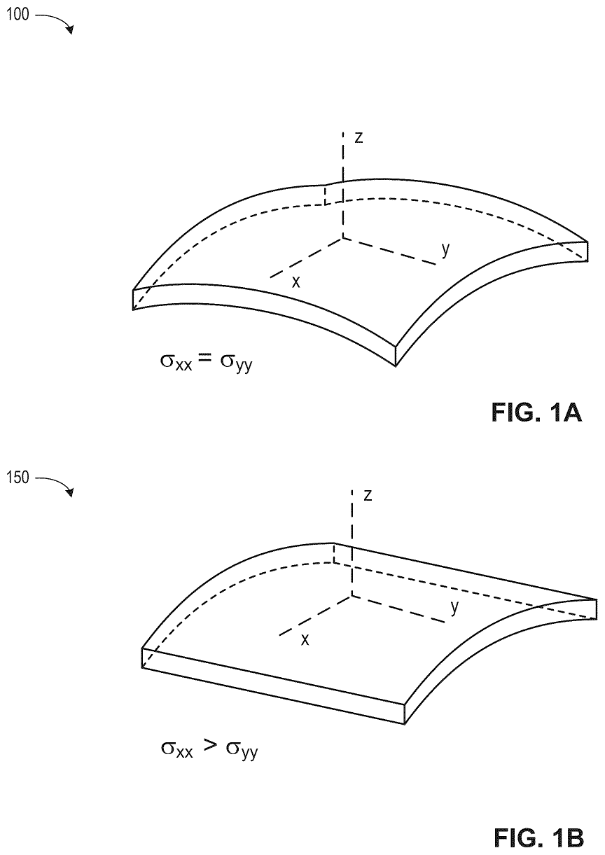

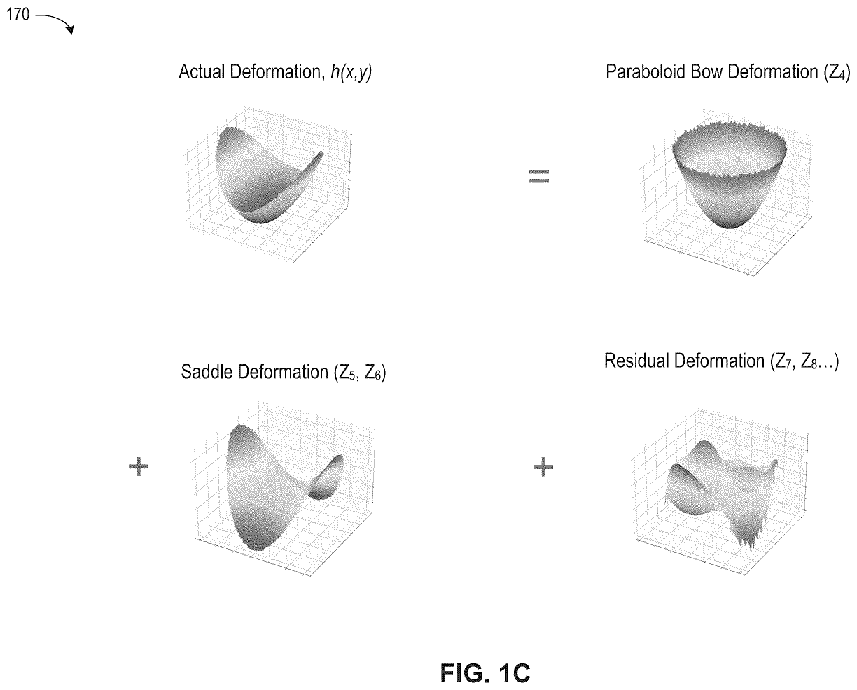

Stress mitigation can be achieved with deposition of a stress-compensation layer (SCL), which can be a film of a material that, being deposited on, e.g., the back side of a wafer (or, in some embodiments, the front side of a wafer), introduces a stress that at least partially negates the stresses caused by patterning and other features placed on the front side of the wafer. Additional control of stresses in the wafer can be achieved with ion implantation into the SCL that modifies (typically, reduces) the amount of stress in the SCL by introducing substitutions and vacancies in the physical structure of the SCL. SCLs and ion implantations can be quite efficient in correcting stresses that are uniform and isotropic, σₓₓ≈σ_{yy}, but mitigating stresses that are anisotropic, σₓₓ≠σ_{yy}, and/or non-uniform (x and/or y-dependent) remains a challenging problem. FIG. 1A illustrates schematically a portion 100 of a uniformly (e.g., parabolically) deformed wafer such that the stress tensor is isotropic σₓₓ≈σ_{yy}. FIG. 1B illustrates schematically a portion 150 of a wafer having anisotropic (e.g., cylindrical) deformation such that the stress tensor is anisotropic σₓₓ>σ_{yy}, where y is the axis of the cylindrical deformation. For a given wafer, orientation of the principal axes of wafer deformation may be determined using information about features formed on the wafer, such as the direction of wordlines/bitlines (which may be known from a technical specification of the performed feature deposition operations), mapping of stresses created by the features, Oxide/Nitride layers, wordline filling material(s), and/or the like. In some embodiments, orientation of the principal axes may be determined using a physical model for the wafer deformation.

Optical inspection can be used to map deformation h(x, y) of a wafer for various locations x, y of the wafer. A uniform and isotropic bow deformation can be compensated by deposition of an SLC of a suitably selected material type and thickness. Further correction of wafer deformations can be achieved by subjecting the SCL to a stress-modification beam, e.g., an ion beam, with a spatially varying dose of the particles of the beam, which corrects remaining local wafer stresses by modifying stresses in the SCL, causing the wafer to flatten. Determining accurate dose maps n(x, y) to achieve such flattening is a challenging problem, which can be addressed by solving a complicated physics problem that includes solving elastic (e.g., plate) equations for the wafer, modeling the dependence of elastic properties of a particular SCL on the received dose(s), and/or the like. Such physics modeling can be time-consuming and costly in terms of necessary processing power and memory resources.

Aspects and embodiments of the present disclosure address these and other challenges of the modern semiconductor manufacturing technology by providing for machine learning systems and techniques capable of correcting wafer deformations using machine learning techniques. A machine learning model (MLM) may be trained to determine, given a measured h(x, y) profile of wafer deformation, a dose map n(x, y) that leads to the maximum mitigation of stresses in the wafer (or wafer-SCL structure). The MLM may be trained using training data that includes a set of deformations of wafers {hⱼ(x, y), j=1, 2, . . . . N} and a set of corresponding dose maps {nⱼ(x, y), j=1, 2, . . . . N}, e.g., determined using the physics model or some other suitable tools. The trained MLM model can be applied to process new inference data, e.g., a wafer deformation h(x, y) that has not been previously seen (processed) by the MLM in training, and generate a dose map n(x, y) for mitigation of the stresses in the wafer. In some embodiments, the trained MLM may further generate parameters of the SCL, e.g., material type, thickness, and/or the like.

The stress-modification beam can include matter particles (e.g., ions, electrons), electromagnetic waves (e.g., UV light, visible light, infrared light, etc.), and/or a suitable combination thereof. The stress-modification beam strikes the SCL and changes the bonding network of the SCL. For example, the stress-modification beam of low energy can interact with surface atoms of the SCL, e.g., removing some of the surface atoms, effectively implementing etching of surface regions of the SCL. The effectiveness of such etching can be controlled by a choice of ion species/radicals/ambient gasses. In another example, the stress-modification beam of high energy can deposit ions inside the SCL. Ions and/or photons of the beam can break bonds of the bonding network (or crystal lattice) of the SCL forming vacancies therein, and can further cause annealing due to local heating, UV curing, and/or other effects. Substitution defects and/or vacancies created by the particles of the stress-modification beam modify (e.g., reduce) stress in the SCL and, through the SCL, in the wafer. The intensity and/or dose (the intensity integrated over time) of the stress-modification beam can vary with the location within the SCL and can be determined (e.g., simulated, modeled, etc.) in a way that maximally relieves the stress in the SCL (and, further, in the wafer). This causes the combination of the wafer, the deposited layers/films, and the SCL to flatten and facilitates precise alignment of features that are patterned on the wafer, etched in one or more stacks of layers, and/or the like, and improves quality of the manufactured devices. The intensity/doses of irradiation can be determined based on measured deformation of the wafer (with layers/films/mask deposited thereon), e.g., using various optical measurement techniques. Multiple techniques can then be used to as part of training of the MLM, e.g., solving elastic plate equations that describe deformation of the wafers, performing statistical simulations, e.g., Monte Carlo simulations, using influence (Green's) function computations, and/or other techniques, as disclosed in more detail herein.

Advantages of the disclosed embodiments include but are not limited to fast and accurate computation of dose maps for efficient mitigation of wafer deformations in manufactured semiconductor products, for precise alignment of features manufactured on wafers and/or other substrates.

A “wafer,” as used herein, refers to any substrate or material surface formed on a substrate upon which film processing is performed during a fabrication process. For example, a wafer surface on which processing can be performed includes materials such as silicon, silicon oxide, silicon nitride, strained silicon, silicon on insulator, carbon doped silicon oxides, amorphous silicon, doped silicon, germanium, gallium arsenide, glass, sapphire, and any other materials such as metals, metal nitrides, metal alloys, and other conductive materials, depending on the application. Wafers include, without limitation, semiconductor wafers. In some instances, wafers can include plastic substrates. Wafers can be exposed to a pretreatment process to polish, etch, reduce, oxidize, hydroxylate, anneal, UV cure, e-beam cure and/or bake the substrate surface. In addition to film processing directly on the surface of the wafer itself, any of the film processing steps disclosed can also be performed on an underlayer formed on the wafer as disclosed in more detail below, and the term “wafer surface” is intended to include such underlayer as the context indicates. Thus, for example, where a film/layer or partial film/layer has been deposited onto a wafer surface, the exposed surface of the newly deposited film/layer becomes the wafer surface. In some embodiments, wafers have a thickness in the range of 0.25 mm to 1.5 mm, or in the range of 0.5 mm to 1.25 mm, in the range of 0.75 mm to 1.0 mm, or more. In some embodiments, wafers have a diameter of about 10 cm, 20 cm, 30 cm, or more.

FIG. 1C illustrates an example Zernike polynomial decomposition 170 that can be used to characterize deformation of a wafer, according to at least one embodiment. The top left portion of FIG. 1C illustrates an example deformation h(x, y) of a wafer, in arbitrary units; the top right portion of FIG. 1C illustrates a paraboloid bow component of the deformation; the bottom left portion of FIG. 1C illustrates a saddle component of the deformation; and the bottom right portion of FIG. 1C illustrates residual deformation.

In one embodiment, an amount of stress in the wafer (and films that can be deposited thereon) can be determined by measuring a vertical profile of the wafer deformation h(\vec{r}), where r=(x, y), e.g., using one or more optical inspection techniques. The profile can refer to the vertical coordinate, z=h(\vec{r}), of the top surface of the SCL or wafer/stack of films (if the measurement is performed prior to SCL deposition). For example, an interferogram of the profile h(\vec{r}) can be obtained using optical interferometry measurements. In some embodiments, the measured wafer deformation h(\vec{r})=h_{quad}(\vec{r})+hᵣₑₛ(\vec{r}) can be represented as a combination of a quadratic h_{quad}(\vec{r}) and residual (non-quadratic) hᵣₑₛ(\vec{r}) contributions. The quadratic deformation can include a parabolic (paraboloid bow) part hₚₐᵣ(r), which has the axial symmetry, and a saddle part h_{saddle}(\vec{r}).

To characterize the geometry of the wafer deformation h(\vec{r}), a suitable set of parameters can be selected. For example, a set of Zernike (or a similar set of) polynomials can be used to represent the wafer profile,

$$h ( \vec{r} ) = {\sum }_{j} {A}_{j} {Z}_{j} ( \vec{r} ) ,$$

where the planar radius-vector \vec{r}=(r, ϕ) can be represented as the radial coordinate r and the polar angle ϕ within the (average) plane of the wafer. Consecutive coefficients A₁, A₂, A₃, A₄ . . . represent weights of specific geometric features (elemental deformations) of the wafer described by the corresponding Zernike polynomials Z₁(r, ϕ), Z₂(r, ϕ), Z₃(r, ϕ), Z₄(r, ϕ) . . . . (Herein, the Noll indexing scheme for the Zernike polynomials is being referenced.) The first three coefficients are of less interest as they describe a uniform shift of the wafer (coefficient A₁, associated with the Z₁(r, ϕ)=1 polynomial), a deformation-free x-tilt that amounts to a rotation around the y-axis (coefficient A₂, associated with the Z₂(r, ϕ)=2r cos ϕ polynomial), and a deformation-free x-tilt that amounts to a rotation around the x-axis (coefficient A₃, associated with the Z₃(r, ϕ)=2r sin ϕ polynomial) that can be eliminated by a realignment of the coordinate axes. The fourth coefficient A₄ is associated with Z₄(r, ϕ)=\sqrt{3}(2r²−1) and characterizes an isotropic paraboloid bow deformation. The fifth A₅ and the sixth A₆ coefficients are associated with Z₅ (r, ϕ)=\sqrt{6} r² sin 2ϕ and Z₆(r, ϕ)=\sqrt{6} r² cos 2¢ polynomials, respectively, and characterize a saddle-type deformation. The A₅ coefficient characterizes a saddle shape that curves up (A₅>0) or down (A₅<0) along the diagonal y=x and curves down (A₅>0) or up (A₅<0) along the diagonal y=−x. The A₆ coefficient characterizes a saddle shape that curves up (A₆>0) or down (A₆<0) along the x-axis and curves down (A₆>0) or up (A₆<0) along the y-axis. The higher coefficients A₇, A₈, etc., characterize progressively faster variations of the wafer deformation h(r, ϕ) along the radial direction, along the azimuthal direction, or both and collectively represent a residual deformation,

$${h}_{r e s} ( r , ϕ ) = h ( r , ϕ ) - {\sum }_{j = 4}^{6} {A}_{j} {Z}_{j} ( r , ϕ ) .$$

In some embodiments, the measured profile of the wafer deformation h(\vec{r}) can be used to identify the stresses that exist in the wafer, σ(\vec{r}), e.g., by solving (or modeling) the equation of elasticity (such as the thin plate equation) that describes a mechanical state of the deformed wafer. In some instances, stress in the wafer can be uniform and isotropic, σₓₓ≈σ_{yy}. In some instances, stress in the wafer can be anisotropic, σₓₓ+σ_{yy}. Certain feature patterns can result in stresses that are compressive along one direction, e.g., σₓₓ<0, and tensile along a perpendicular direction, σ_{yy}>0, resulting in saddle-shaped wafers.

In some embodiments, a thickness of the stress-compensation layer (SCL) can be computed (or empirically determined) in such a way that the SCL applies a desired target stress to the wafer. To eliminate a non-uniform saddle deformation, SCL can be of such thickness/material as to turn the saddle deformation into a cylindrical deformation having a definite sign throughout the area of the wafer. The uniform-sign cylindrical deformation (as well as a residual higher-order non-quadratic deformation) can be mitigated by irradiation with a stress-modification beam. In some embodiments, a cylindrical decomposition is not unique and can be either positive (upward-facing cylindrical deformation) or negative (downward-facing cylindrical deformation). Both decompositions can be analyzed and a decomposition that allows a more effective stress mitigation can be selected. For example, a decomposition that is characterized by a smaller parabolic bow deformation can be selected. The parabolic bow deformation can be mitigated using a choice of SCL (e.g., type and thickness) while the remaining cylindrical deformation (and the higher-order residual deformation) can be addressed by appropriately selected ion or photon irradiation dose n(\vec{r}).

In some embodiments, mitigation of a cylindrical deformation or a saddle deformation can include identifying principal axes (directions) of the cylinder/saddle and a magnitude of the cylindric/saddle deformation and directing the stress-modification beam into appropriately selected edge regions of the SCL. In some embodiments, the axes of the saddle deformation can be parallel and perpendicular to the direction of the features deposited (or otherwise formed) on the wafer.

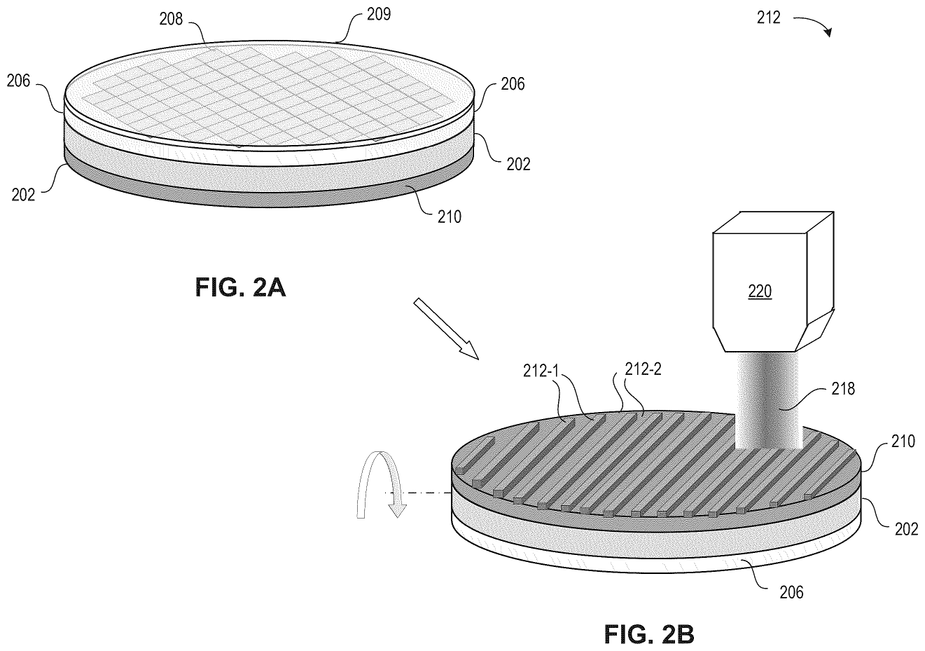

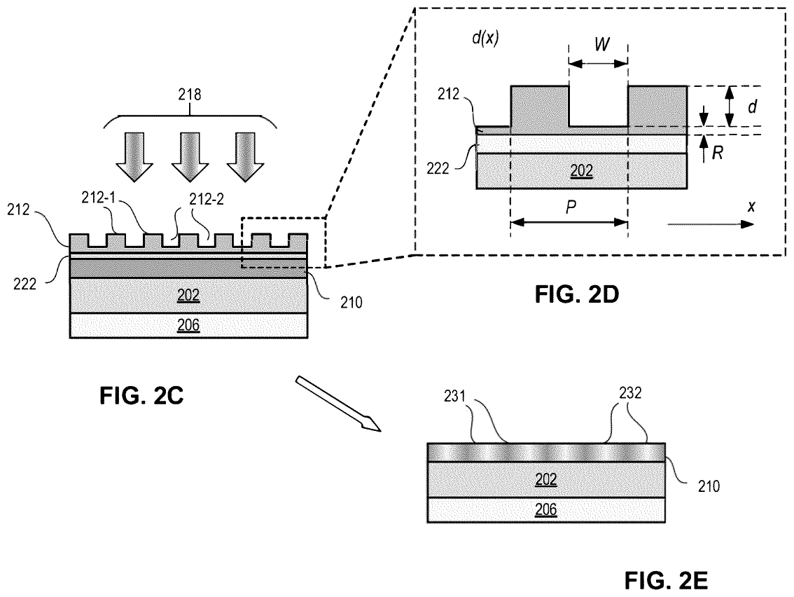

FIGS. 2A-2E show an example wafer-wide view of a process of semiconductor manufacturing, according to at least one embodiment. FIG. 2A shows a wafer 202, which can be a bare wafer or a wafer with one or more features patterned thereon (e.g., source lines of NAND devices). In some embodiments, wafer 202 can undergo any appropriate additional treatment, such as annealing. A stack of one or more films 206 can be deposited on wafer 202. Stack 206 can include uniform (unpatterned) or patterned films. For example, a set of features 208 can be formed within at least some of films of stack 206, e.g., using photolithography and/or other techniques. Features 208 can include chip boundaries, area boundaries, slits, channels, and/or any other applicable features. In some embodiments, a frontside protection layer 209 can be deposited to protect stack 206 during wafer handling and manipulations using various mechanical effectors. As further shown in FIG. 2A, an SCL 210 can be deposited on the back side of wafer 202.

As further shown in FIG. 2B, with the back side of wafer 202 facing up, a suitable directional patterned mask 212 can be manufactured on the SCL 210. (For simplicity, FIG. 2B does not show frontside protection layer 209. “Directional pattern,” as used herein, refers to any pattern having characteristic length scale(s) of associated features along one direction substantially exceeding, e.g., by factor 3, 5, 10, or more, a characteristic length of the features along the other direction. An example directional pattern can include gratings with a pitch of 10 nm-100 μm or more and length of lines of 10 μm-1 cm or more. In some embodiments, the directional patterned mask 212 can be made of a different material than SCL 210. For example, directional patterns can be or include a photoresist mask deposited on SCL 210. In some embodiments, the directional patterned mask 212 can be made of the same material as SCL 210. In some embodiments, the directional patterned mask 212 can be etched in SCL 210. In some embodiments, the directional pattern can include raised portions 212-1 (e.g., ridges, protrusions, elevations, etc.) and recessed portions 212-2 (e.g., trenches, grooves, ruts, dips, etc.).

The directional patterned mask 212 and SCL 210 can be subjected to irradiation by a stress-modification beam 218. Stress-modification beam 218 can be generated by a suitable collimating and focusing column 220. As illustrated in FIG. 2C for a portion of the wafer 202, the directional patterned mask 212 modulates the amount of irradiation that reaches SCL 210. For example, the portions of SCL 210 that are located below raised portions 212-1 of directional patterned mask 212 (protected areas) can be shielded to a higher degree than the portions of SCL 210 that are located below recessed portions 212-2 (stress-mitigated areas).

As further illustrated in FIG. 2C, in some embodiments, an additional coating layer 222 can be deposited between SCL 210 and directional patterned mask 212, e.g., one or more anti-reflective coating (ARC) layers or adhesion-promoting materials, such as Hexamethyldisilazane (HMDS) or similar layers. Stress-modification beam 218 can then be applied to directional patterned mask 212. In some embodiments, stress-modification beam 218 can be a high-energy ion beam depositing ions inside directional patterned mask 212. In some embodiments, stress-modification beam 218 can be a low-energy ion beam mitigating stress by etching regions of SCL 210 exposed by recessed portions 212-2 of directional patterned mask 212.

FIG. 2D is a cross-sectional view of an example non-limiting geometry of directional patterned mask 212, according to one embodiment. The directional patterned mask 212 illustrated in FIG. 2D has the form of a grating with a profile d(x) that includes a set of rectangular (or near rectangular) raised portions of height d, e.g., 100 nm-10 μm, and separated by trenches of width W, e.g., 100 nm-100 μm. A period of grating P (pitch) can be 200 nm-200 μm, or have any other suitable value. In some embodiments, height d can be significantly larger than a residual height, d>>R. Although FIGS. 2B-2D illustrate masks patterned along one direction d(x), mitigation of stresses caused by dies can be achieved by further patterning the masks along the second direction, d(x, y).

FIG. 2E illustrates the portion of the wafer from FIG. 2C after irradiation by stress-modification beam 218. As depicted schematically in FIG. 2E, protected areas 231 of SCL 210 (indicated with darker shading) can have more residual stress than stress-mitigated areas 232 (indicated with lighter shading). Directional patterned mask 212 and/or coating layer 222 can be removed after irradiation, e.g., dissolved, polished, evaporated, and/or the like. Application of stress-modification beam 218 causes stress in SCL 210 to decrease, resulting in the flattening of the structure (reduced deformation). The reduction of stress in SCL 210 also causes the stress in wafer 202 and/or stack 206 to be reduced.

As a result of operations illustrated with FIGS. 2A-2E, a spatially modulated directional patterned structure is formed in SCL 210 where regions of higher stress (e.g., protected areas 231) are interspaced with regions of lower stress (stress-mitigated areas 232) using a deposited directional patterned mask 212 that shields the protected areas of SCL 210 from stress-modification beam 218, e.g., a modification beam of a wide cross-sectional area.

In some embodiments, selection of a thickness of SCL 210 can be based on a value of the paraboloid bow coefficient A₄. SCL 210 can be deposited using any suitable deposition techniques including physical vapor deposition (e.g., sputtering), chemical vapor deposition (e.g., plasma-assisted deposition), epitaxy, exfoliation, and/or the like. Deposition can be performed at room temperature or at temperatures different from room temperature (e.g., at an elevated temperature). The thickness of SCL 210 can be selected to overcorrect the wafer deformation, to some degree. The overcorrection can be chosen in conjunction with a type of stress-modification beam 218 (e.g., ion implants, photons, electrons, etc.), a type of implant species (e.g., ions of specific elements), energy, and dose to ensure maximum effect from the stress mitigation. Stress in the combined structure of the wafer, films, and the SCL can then be modified by stress-modification beam 218 that strikes SCL 210 and changes its physical structure. Substitution defects and/or vacancies created by the beam mitigate (e.g., reduce) stress in SCL 210 and can reduce the degree of stress overcorrection caused by deposition of SCL 210. This leads to flattening of wafer 202.

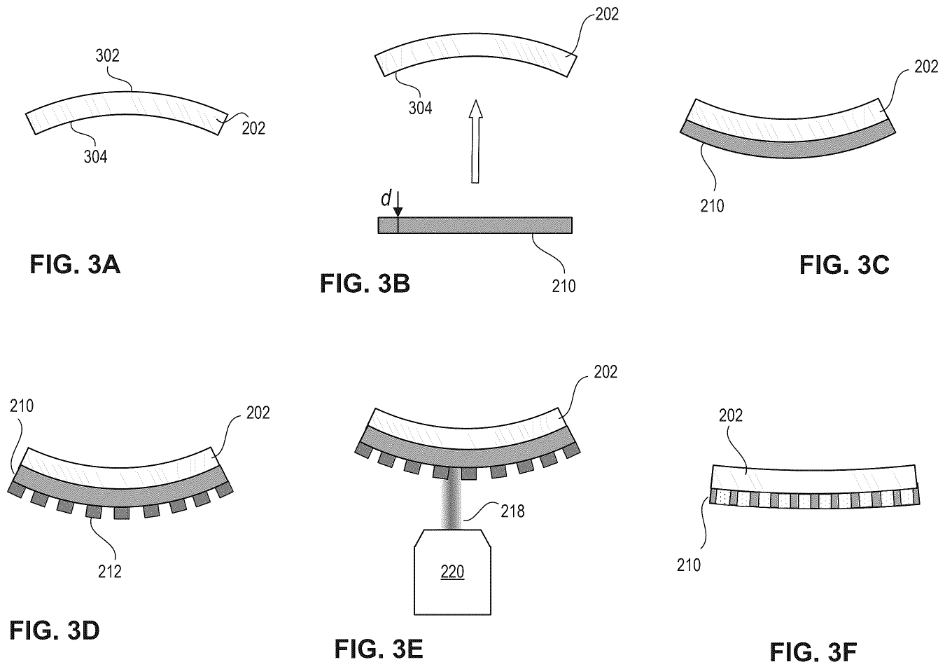

FIGS. 3A-F illustrate schematically a process of correcting wafer deformation using a stress-modification beam applied to a stress compensation layer deposited on a back side of a wafer and partially shielded by a patterned mask, according to at least one embodiment. FIG. 3A depicts a wafer 202 having a deformation, which can include a paraboloid bow deformation (with negative coefficient A₄<0, as illustrated) and can further include other deformations, such as saddle deformation, residual deformation, etc. The wafer's front side 302 can support any number of features, e.g., deposition and/or etching patterns, a stack of layers/films, and/or any other structures. FIG. 3B illustrates deposition of an SCL 210 on the back side 304 of wafer 202. In some embodiments, SCL 210 can include layers of multiple materials. In some embodiments, a material of SCL 210 can be selected in view of the sign of coefficient A₄. For example, for a negative bow, A₄<0, SCL 210 can be selected to have a compressive stress (as illustrated in FIGS. 3B-3E). For silicon wafers, such a film can be a silicon nitride (Si₃N₄) film or silicon oxide (SiO₂) film. Conversely, for a positive bow, A₄>0, SCL 210 can be selected to have a tensile stress (not shown in FIGS. 3B-3F). SCL 210 can be deposited using any suitable deposition techniques including physical vapor deposition (e.g., sputtering), chemical vapor deposition (e.g., plasma-assisted deposition), epitaxy, exfoliation, and/or the like. Deposition can be performed at room temperature or at temperatures different from room temperature (e.g., at an elevated temperature). In some embodiments, a thickness d of SCL 210 can be selected to overcorrect the wafer deformation to some degree, e.g., as illustrated in FIG. 3C where a negative paraboloid bow is overcorrected to a positive paraboloid bow. The thickness-dependent paraboloid bow correction A_{corr}(d) changes wafer deformation from h(r, ϕ) to h_{corr}(r, ϕ):

$${h}_{c o r r} ( r , ϕ ) = h ( r , ϕ ) + {A}_{c o r r} ( d ) \cdot {Z}_{4} ( r , ϕ ) .$$

The degree of overcorrection can be chosen in conjunction with a type and parameters (e.g., energy, dose, etc.) of a specific stress-modification beam to be used on SCL 210. The overcorrection can make the combined structure of wafer 202 and SCL 210 susceptible to further control of stress (and thus control of deformation of the wafer h_{corr}(r, ϕ)).

As illustrated in FIG. 3D, SCL 210 can be used in conjunction with a directional patterned mask 212 that provides a local shielding of SCL 210 from a stress-modification beam 218. As illustrated in FIG. 3E, collimating and focusing column 220 can generate stress-modification beam 218 that strikes SCL 210 and changes its elastic properties, e.g., by creating vacancies, breaking crystal bonds, depositing ions, and/or via any other applicable mechanisms. Stress-modification beam 218 can carry photons, electrons, silicon ions, phosphorus ions, argon ions, neon ions, xenon ions, krypton ions, and/or the like. In some embodiments, the energy and type of ions in stress-modification beam 218 can be selected to limit the implanted ions to the volume of SCL 210 without allowing the ions to reach wafer 202 (and/or any layers/films deposited on wafer 202). Ions that lodge in SCL 210 create substitution defects therein. Additionally, the ions leave a trail of vacancy defects along paths of propagation in SCL 210. The substitution defects and/or vacancies mitigate (e.g., reduce) stress in SCL 210 and can reduce the degree of stress overcorrection caused by the SCL deposition. This causes the combination of wafer 202 and SCL 210 to flatten.

In some embodiments, the number of ions ΔNᵢ deposited per small area ΔA=ΔxΔy (or the total amount of photon energy applied to this area) of wafer 202 can be determined using simulations (performed as described in more detail below) based on the local value of the corrected deformation h_{corr}(r, ϕ), which can include a saddle deformation, a residual deformation, and the part of the paraboloid bow deformation A_{corr}(d)+A₄ that has been overcorrected by the deposition of SCL 210. The target local density n(x, y)=ΔNᵢ/ΔxΔy of the ions can be delivered by controlling the scanning velocity v of stress-modification beam 218. In some embodiments, stress-modification beam 218 has a profile that can be approximated with a Gaussian function, e.g., the ion flux j(ρ)=j₀ exp(−x²/a²−y²/b²), where x and y are Cartesian coordinates, j₀ is the maximum ion flux at the center of the beam, and a and b is are characteristic spreads of the beam along the x-axis and y-axis, respectively. Correspondingly, a point that is located at distance y from the path of the center of the beam receives an ion dose that has the following number of ions:

$$\frac{Δ {N}_{i}}{Δ x Δ y} = \frac{{j}_{0}}{v} {\int }_{- ∞}^{∞} dx {e}^{- {x}^{2} / {a}^{2} - {y}^{2} / {b}^{2}} = \frac{{j}_{0} \sqrt{π}}{v a} {e}^{- {y}^{2} / {b}^{2}} .$$

Correspondingly, by reducing the scanning velocity v, the number of ions received by various regions of SCL 210 can be increased, and vice versa. Additionally, stress-modification beam 218 can perform multiple scans with different offsets y so that various points of SCL 210 receive multiple doses of ions with different factors e^{-y}^{²}^{/b}^{²} that can average to a target dose. For example, after n passes of stress-modification beam 218, each made with a respective velocity vₖ at a different distance yₖ from the center of the beam to the area ΔxΔy, the total dose of ions (or amount of electromagnetic radiation) received by this area will be

$$n ( {x}_{x} y ) = \frac{Δ {N}_{i}}{Δ x Δ y} {\vert}_{total} = {j}_{0} \sqrt{π} {\sum }_{k = 1}^{n} \frac{{e}^{- {y}_{k}^{2} / {b}^{2}}}{a {v}_{k}} .$$

As illustrated in FIG. 3F, the alternating pattern of stress-mitigated areas and protected areas formed in SCL 210 by the stress-modification beam 218 and directional patterned mask 212 results in a significant mitigation of cylindrical deformation of wafer 202 and can further mitigate paraboloid and residual deformations.

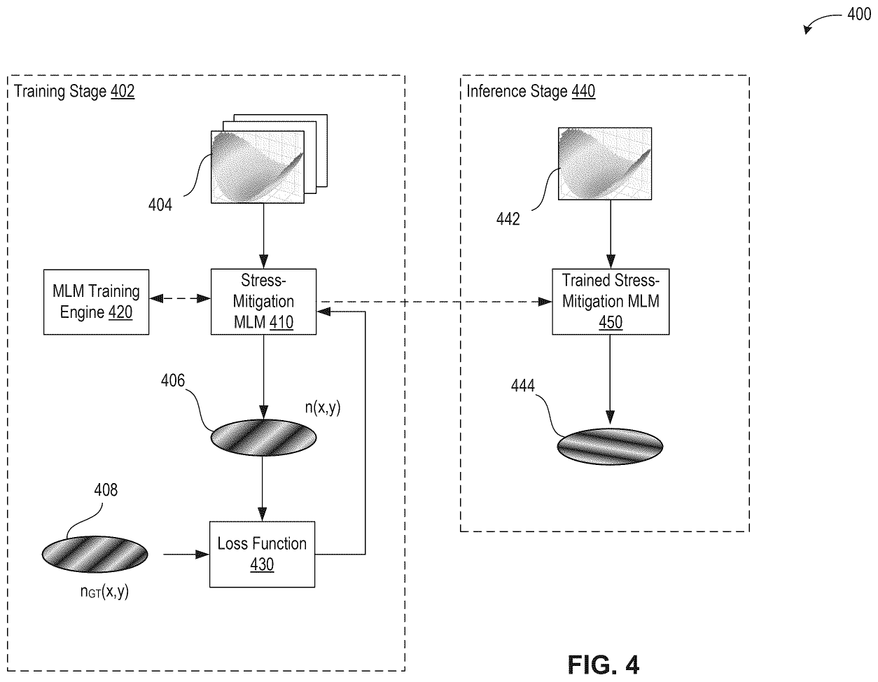

FIG. 4 illustrates an example computer architecture 400 that deploys a stress-modification machine-learning model (MLM) to determine doses of particles (or photons) of a beam used for mitigation of stresses in wafers, according to at least one embodiment. Example computer architecture 400 can include a training stage 402 to train a stress-modification MLM 410 using appropriate training data and an inference stage 440 to apply the trained stress-modification MLM 450 to a new data.

Stress-modification MLM 410 can be or include one or more decision-tree algorithms, support vector machines, deep neural networks with one or more hidden layers, or any combination thereof. Deep neural networks may include convolutional neural networks (CNNs), recurrent neural networks (RNN), fully connected neural networks, long short-term memory (LSTM) neural networks, Boltzmann machines, U-net neural networks, encoder-decoder neural networks, neural networks with attention, transformer neural networks, and/or neural networks of any suitable architecture.

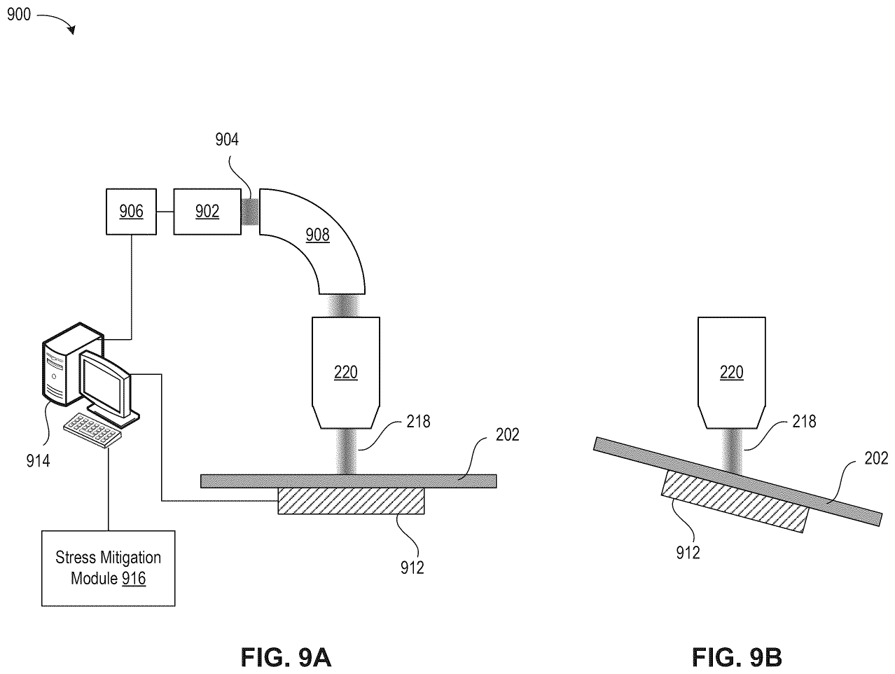

Stress-modification MLM 410 can be trained by an MLM training engine 420. MLM training engine 420 can be part of irradiation system 900 of FIG. 9, e.g., part of controller 914, or some other processing device of irradiation system 900. In some embodiments, MLM training engine 420 can be part of a processing device that is separate from irradiation system 900. In some embodiments, MLM training engine 420 can be located on a server that is separate from irradiation system 900, with the trained MLM being installed as part of irradiation system 900 after training stage 402 is completed.

During training stage 402, stress-modification MLM 410 undergoing training can receive training input 404. Training input 404 can include wafer deformation of one of previously processed real wafers. Wafer deformation of a wafer can be measured using optical inspection techniques, in some embodiments. Wafer deformation included in training input 404 can include a map of deformation of a wafer prior to application of the stress-modification beam. For example, wafer deformation can include deformation h_{SCL}(x, y) of the wafer after an SCL has been deposited on the wafer. In some embodiments, wafer deformation can include wafer deformation h(x, y) prior to deposition of the SCL. In some embodiments, the training input 404 can also include a wafer deformation h_{POST}(x, y) after application of stress-modification beam.

Stress-modification MLM 410 can process training input 404 and predict a dose map n(x, y) 406 to corrects the wafer deformation h(\vec{r}). In some embodiments, the output of stress-modification MLM 410 can also include parameters of the deposited SCL or parameters of the SCL to be deposited prior to application of the stress-modification beam, said parameters including a material type and thickness of the SCL. In some embodiments, the parameters of the SCL may be determined separately (e.g., using a physics model) and used as part of training input 404 into stress-modification MLM 410. In some embodiments, training input 404 can further include settings of the stress-modification apparatus, e.g., species, energy, profile, etc. of the stress-modification beam.

MLM training engine 420 can use training inputs 404 and corresponding target outputs (e.g., dose maps n_{GT}(x, y) 408) to train stress-modification MLM 410 to find patterns in the training data and match training inputs 404 to the target outputs, e.g., to match wafer deformation h(x, y) to ground truth (target) dose maps n_{GT}(x, y) 408. MLM training engine 420 can deploy a suitable loss function 430 to compare the predicted dose map n(x, y) 406 to a target dose map n_{GT}(x, y), e.g., a dose empirically determined or computed for the wafer deformation h(x, y) of training input 404. In some embodiments, the ground truth dose maps n_{GT}(x, y) 408 can be determined using a physics model. The computed loss function 430 can be used to modify parameters (e.g., neural weights and biases) of the stress-modification MLM 410, e.g., using techniques of backpropagation, gradient descent, and/or the like. In some embodiments, loss function 430 can be (or include) a mean squared error loss function, a mean absolute error loss function, a binary cross-entropy loss function, a hinge loss function, a Huber loss function, a log-cosh loss function, and/or any other suitable loss function. In some embodiments, various techniques that prevent overfitting can be deployed, including but not limited to neural node dropout, K-fold cross validation, and/or the like.

In some embodiments, the training data used during training stage 402 can be normalized. In some embodiments, various techniques of training data augmentation can be used to increase the size of the training set. For example, a given wafer shape h(x, y) (and, similarly, the post-beam application shape h_{POST}(x, y)) can be rotated to various angles (around the vertical axes) and then used as separate training inputs 404, to more efficiently train stress-modification beam to recognize and process various wafer deformations.

In some embodiments, ground truth dose maps n_{GT}(\vec{r}) can be determined by solving the elastic plate equation for a wafer, e.g., using a finite difference method or other techniques of solving partial differential equations. Determining the ground truth dose maps n_{GT}(\vec{r}) can further include using a model that relates local elastic properties (e.g., Young modulus, Poisson's ratio, and/or the like) of a wafer to a received doses of a specific type of particles having specific energy, and/or the like.

In some embodiments, ground truth dose maps n_{GT}(\vec{r}), which the MLM is trained to emulate, can be determined using simulations, e.g., Monte Carlo simulations or other statistical simulations. The Monte Carlo simulations can be performed for a film made of the actual SCL material(s) and having a specific thickness d. An initial Monte Carlo simulation can be performed for specific baseline (default) conditions of the particle irradiation (e.g., default settings of an ion implantation apparatus). The baseline conditions can include a default type of particles, a default energy of the particles, a default dose of particles to be applied to the SCL (e.g., a default velocity of scanning and a default scanning pattern), and the like. The baseline conditions can subsequently be modified (e.g., optimized) using the Monte Carlo simulations. The Monte Carlo simulations can use calibration data collected (measured) for actual particle irradiation performed for various ion/photon/electron energies, types of ions, types and materials of SCL(s), angles of particle incidence on the films, and/or the like.

In some embodiments, ground truth dose maps n_{GT}(\vec{r}) can be computed using an influence function G(\vec{r}; \vec{r}′) that characterizes a response (e.g., deformation) at a point \vec{r} of the wafer as caused by a point-like mechanical influence, e.g., a point-like force, applied at another point \vec{r}′ of the wafer. In some embodiments, the influence function G(\vec{r}; \vec{r}′), also known as the Green's function, can be determined from computational simulations or from analytical calculations. In some embodiments, the influence function can be determined from one or more experiments, which can include performing ion implantation into a film deposited on a reference wafer. The Green's function can be previously determined and stored as part of a dataset in a suitable representation, e.g., as a discretized set of values of the Green's function, G(\vec{r}ᵢ; \vec{r}ⱼ).

After training of stress-modification MLM 410, the trained stress-modification MLM 450 can be used, e.g., as part of inference stage 440, to process new (unseen during training) input data 442 and predict dose map n(x, y) 444. In some embodiments, trained stress-modification MLM 450 can be used to predict both dose map 444 and material/thickness of the SCL. In some embodiments, training of stress-modification MLM 410 (during training stage 402) and deployment of trained stress-modification MLM 450 (during inference stage 440) can be subject to various additional constraints, e.g., a maximum dose density not exceeding a set threshold. Such constraint(s) can be learned by stress-modification MLM 410 during training, e.g., by assigning an additional cost, in the loss function 430, to those dose maps that violate the constraint(s) and reducing such costs using backpropagation.

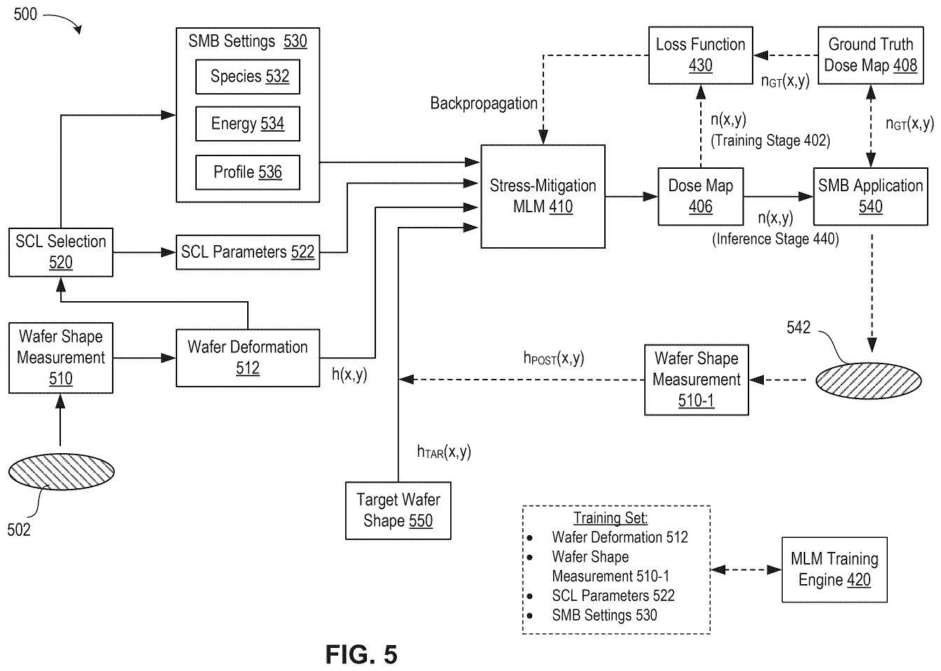

FIG. 5 illustrates an example data flow 500 of training and deploying a stress-modification MLM to determine dose maps for modification of stresses in wafers, according to at least one embodiment. During training, operations of example data flow 500 can be facilitated by MLM training engine 420. During inference, operations of example data flow 500 can be performed by a processing device of an irradiation system (e.g., controller 914 in FIG. 9) used to determine and apply doses of a stress-modification beam. Operations indicated with dashed arrows can be performed as part of training stage 402 (with reference to FIG. 4) while operations indicated with solid arrows can be performed as part of both inference stage 440 and training stage 402.

As illustrated, a wafer 502 can undergo a wafer shape measurement 510 (e.g., using optical interferometry or similar techniques) that identifies a shape (profile) h(x, y) of wafer 502. Wafer 502 can include a bare wafer with any number of films/layers/features deposited or otherwise formed on the bare wafer. The output of the wafer shape measurement 510 can be used to determine wafer deformation 512. For example, the measured shape of the wafer can be decomposed over a suitable set of polynomials, e.g., Zernike polynomials, and a set of polynomial expansion coefficients, {Aⱼ}=(A₁, A₂, A₃), A₄, A₅, A₆, A₇, . . . , can be obtained, each coefficient in the set representing the presence of a particular elemental geometric shape in wafer deformation. Wafer deformation 512 can further include identifications of the principal axes of deformation of wafer 502, e.g., axes of cylindrical deformation, saddle deformation, and/or some combination of such deformations, which can further include parabolic deformation, residual deformation, etc.

Wafer deformation 512 can be used to perform SCL selection 520, which can include selecting a sign of the stress of the SCL, e.g., tensile or compressive, selecting a specific material of the SCL, selecting a thickness of the SCL, selecting an amount of stress in the SCL, selecting a side of the wafer (e.g., front side or back side) of wafer 502 for SCL deposition, and the like.

The wafer deformation 512 and various selected SCL parameters 522 (e.g., material, thickness, stress, side, and/or other characteristics of the SCL) can be used as input into stress-modification MLM 410. Additional input into stress-modification MLM 410 can include settings of a stress-modification beam (SMB) 530, which can include species (type of particles) 532 of the stress-modification beam, e.g., electrons, photons, ions, including a type of the ions (e.g., silicon, phosphorus, argon, neon, xenon, krypton, etc.). Settings of the stress-modification beam 530 can further include energy 534 of species 532. Energy 534 can be specified using a continuous value (e.g., in units of electron-Volts) or a discrete value (e.g., one or several selectable energy bins). Settings of the stress-modification beam 530 can also include profile 536 of the beam, e.g., spatial scales a and b of the beam along various spatial dimensions. During the inference stage, a target wafer shape h_{TAR}(x, y) can be used as an additional input into stress-modification MLM 410. In some embodiments, the target wafer shape h_{TAR}(x, y) 550 can be a flat (e.g., x and y independent) shape. In some embodiments, the target wafer shape 550 can be different from a flat shape, e.g., by a tolerance amount that is not detrimental to alignment of various manufacturing features that are formed or yet to be formed on the wafer. In some embodiments, the target wafer shape 550 can account for the change in deformation that is to occur after additional processing. For example, if a protective film is yet to be removed from the wafer, which is expected to change the deformation of the wafer, the target wafer shape 550 can be such that the wafer becomes flat (or approximately flat) after such removal.

In some embodiments, the target wafer shape h_{TAR}(x, y) 550 is used during the inference stage whereas a measured (after application of stress-modification beam, at block 540, as described in more detail below) shape h_{POST}(x, y) of the wafer is used during training stage. In some embodiments, the target wafer shape h_{TAR}(x, y) and the shape of the wafer h(x, y) prior to application of the stress-modification beam (and/or prior to SCL deposition) are used as separate inputs into stress-modification MLM 410 during the inference stage. (Correspondingly, the post-beam application wafer shape h_{POST}(x, y) and h(x, y) are used as separate inputs into stress-modification MLM 410 during the training stage.) In some embodiments, during the inference stage, the target wafer shape h_{TAR}(x, y) and h(x, y) are used, as input into stress-modification MLM 410, in a combination h_{TAR}(x, y)−h(x, y). (Correspondingly, during the training stage, the combination h_{POST}(x, y)−h(x, y) can be used as the input.)

In the embodiments where stress-modification MLM 410 includes a neural network, wafer deformation 512, target wafer shape h_{TAR}(x, y) 550 (or h_{POST}(x, y), in training) SCL parameters 522, and settings of the stress-modification beam 530 can be fed into an input layer of the neural network. The neural network can include any number of hidden layers and an output layer that outputs a dose map n(x, y) 406. The dose map 406 can include a number of particles (or photons) ΔN received by a unit area (pixel) of the wafer ΔxΔy. The number of pixels M can be a parameter specified by the architecture of stress-modification MLM 410 and can relate to the area A of wafer 502 according to M=A/ΔxΔy. In particular, the output layer of stress-modification MLM 410 can include M channels, each of the channels outputting the respective number of particles ΔN received by the corresponding pixel.

During inference stage 440, the dose map n(x, y) 406 generated by stress-modification MLM 410 can be used in the stress-modification beam application 540. Application of the dose map n(x, y) 406 can include using one or more irradiation techniques. In some embodiments, the irradiation techniques include varying the maximum (peak) current of the stress-modification beam, scanning speed of the beam, a number of passes of the beam over the same locations of wafer 502, and/or the like. In some embodiments, the irradiation techniques include forming a mask that partially protects certain regions of the SCL from the particle of the beam, e.g., as disclosed in conjunction with FIGS. 2B-2E.

During training stage 402, in some embodiments, stress-modification beam application 540 to an actual wafer is not performed. Instead, ground truth dose map n_{GT}(x, y) 408 can be used, which can be computed using a physical model of wafer deformation and/or a model characterizing modification of stresses in SCL from interaction of the stress-modification beam with the SCL, and/or the like. Loss function 430 can be used to evaluate the difference between the two dose maps e.g., by computing the total loss (cost, mismatch) for the wafer, e.g., as the mean squared difference between the two dose maps,

$$L = \int \int {[ {n}_{G T} ( x , y ) - n ( x , y ) ]}^{2} dxdy .$$

Although the continuum integral is used to define loss L in this example, in embodiments, a corresponding discrete sum can be computed instead over pixels of the dose maps. Various techniques of backpropagation, gradient descent, and/or the like can be used to change various parameters (weights and biases) of stress-modification MLM 410 to reduce the loss L by bringing the predicted dose map n(x, y) closer to the target dose map n_{GT}(x, y).

In some embodiments, the training stage of stress-modification MLM 410 is performed using both the wafer deformation h(x, y) 512 measured (by wafer shape measurement 510) before stress-modification beam application 540 and deformation h_{POST}(x, y) of the wafer 542 measured after such application, e.g., by a subsequent wafer shape measurement 510-1, and used in lieu of h_{TAR}(x, y).

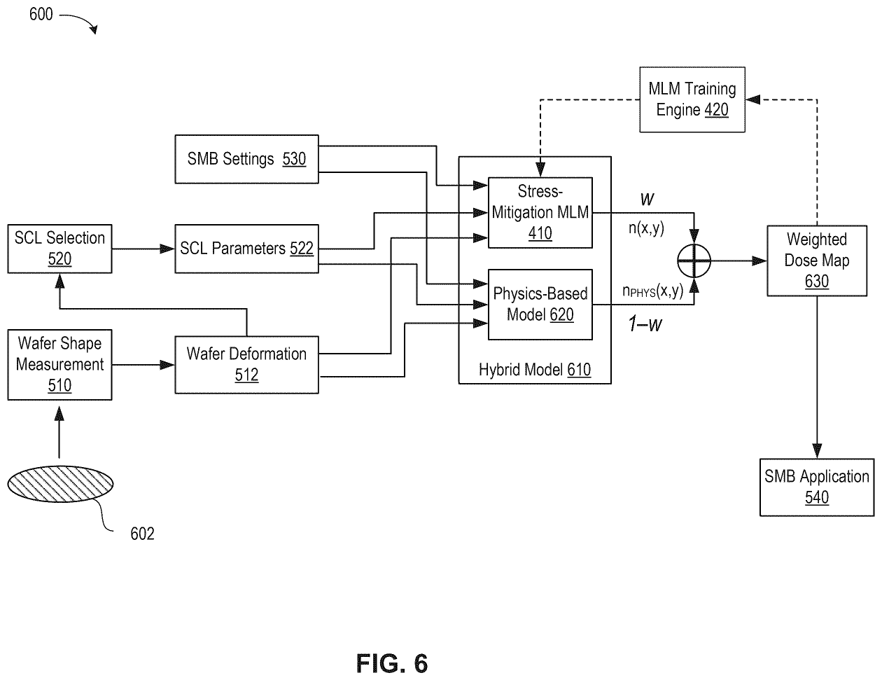

FIG. 6 illustrates an example data flow 600 of deploying a hybrid model, which includes a combination of a stress-modification MLM and a physics model, to determine dose maps for modification of stresses in wafers, according to at least one embodiment. A hybrid model 610 can include stress-modification MLM 410, operating and trained substantially as disclosed in conjunction with FIG. 5, in one embodiment. In particular, an input into stress-modification MLM 410 can include wafer deformation 512 (obtained by performing wafer shape measurement 510 of a wafer 602), SCL parameters 522 (e.g., selected by SCL selection 520), stress-modification beam settings 530 and or other suitable inputs. Stress-modification MLM 410 can output a predicted dose map n(x, y). MLM training engine 420 can perform training of stress-modification MLM 410, e.g., as disclosed in conjunction with FIG. 4 (and as indicated schematically with the dashed arrow in FIG. 5.)

Additionally, a hybrid model 610 can be deployed that includes a physics-based model 620. Physics-based model 620 can use the same inputs (e.g., wafer deformation 512, SCL parameters 522, stress-modification beam settings 530, and/or the like) to output a separate predicted dose map n_{PHYS}(x, y). Physics-based model 620 can use one or more techniques to solve elastic plate equation for wafer 602, to model the dependence of elastic properties of an SCL on a received dose of the stress-modification beam, to account for mechanical interaction between wafer 602 and SCL deposited thereon, and/or the perform other suitable calculations.

A weighted dose map 630 can be obtained by combining the MLM-predicted dose, weighted with weight w, with the physics model-predicted dose, weighted with weight 1−w, e.g.,

$${n}_{W} ( x , y ) = w n ( x , y ) + ( 1 - w ) {n}_{PHYS} ( x , y ) .$$

The weighted dose map n_{W}(x, y) 630 can be used in implementing stress-modification beam application 540.

The relative weights of the two contributions can be adjusted as stress-modification MLM 410 is trained with progressively larger amounts of (collected) training data. For example, initially, the weight given to stress-modification MLM 410 predictions can be small but can increase as stress-modification MLM 410 is trained with additional data. As the amount of training data processed by stress-modification MLM 410 grows and predictions of stress-modification MLM 410 improve (e.g., as quantified by a suitable loss function, e.g., loss function 430 in FIG. 4 and FIG. 5), weight w gradually increases from w≈0 to w≈1.

The use of hybrid model 610 enables training stress-modification MLM 410 without stopping a wafer manufacturing process while ensuring that the used doses remain accurate. Initially, operations of physics model 620 can consume substantial processing and/or memory resources. As the weight of the stress-modification MLM reaches w=1, the use of physics model 620 can be discontinued and further processing can be performed using the faster and more economical stress-modification MLM 410 alone.

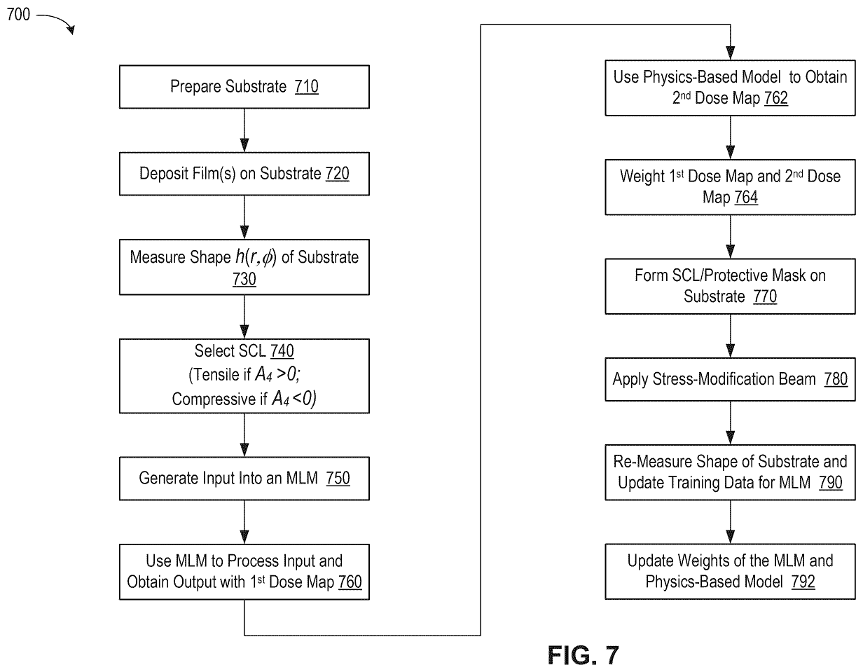

FIG. 7 is a flowchart illustrating an example method 700 of using a machine learning model to facilitate modification of stresses in substrates, according to at least one embodiment. Method 700 can be performed using a semiconductor manufacturing system that includes one or more processing chambers, e.g., deposition chamber(s), plasma chamber(s), etching chamber(s), polishing chamber(s), film removal chamber(s), beam irradiation chamber(s), optical inspection chamber(s), and/or the like. The processing chambers can be connected to one or more transfer chambers, which can be equipped with robot(s) to handle substrates, e.g., moving substrates into and out of processing chambers. The transfer chamber can further be connected to a load-lock chamber (Front-End Interface) that can be coupled to one or more Front Opening Unified Pod carriers that hold bare substrates, processed substrates, partially processed substrates, and/or the like. Operations performed by the semiconductor manufacturing system, including any, some or all operations of method 700, can be performed responsive to instructions issued by a suitable computing device having a processing logic and memory to store the instructions.

At block 710, method 700 can include preparing a substrate, including but not limited to obtaining a bare substrate, preprocessing the bare substrate, e.g., polishing the substrate, removing stains and/or residue from the substrate, and/or the like, and/or performing any number of similar operations. At block 720, method 700 can continue with depositing one or more films/layers on the substrate. The layers can include a layer of conducting features, e.g., source lines to be used as part of memory cell (transistor) circuitry, alternating Nitride and Oxide layers, silicon layers, silicon-germanium alloy layers, and/or any suitable features. At block 730, method 700 includes measuring the shape of the substrate, e.g., a displacement of a surface (e.g., the top surface) of a substrate as a function of some in-plane coordinates, e.g., polar coordinates z=h(r, ϕ), Cartesian coordinates, z=h(x, y), or any other suitable coordinates. In some embodiments, the measured shape of the substrate can include decomposition of the shape over a suitable set of polynomials, e.g., Zernike polynomials, and obtaining a set of polynomial expansion coefficients, {Aⱼ}=(A₁, A₂, A₃), A₄, A₅, A₆, A₇, . . . , each coefficient in the set characterizing a degree of presence of a particular elemental geometric shape in the substrate's deformation.

In some embodiments, method 700 can include a decision-making block 740 to select a type of SCL to be used with the substrate. For example, a decision at block 740 can be made based on the coefficient that determines a degree of parabolicity of the deformation, e.g., coefficient A₄. If the substrate is curved downwards (towards the back side of the substrate, so that the edges of the substrate are lower than its center), A₄<0, a compressive SCL can be selected for the back side deposition. If A₄>0, a tensile SCL can be selected for back side deposition. In some embodiments, e.g., where a front side deposition is used, the selection of compressive SCL vs. tensile SCL can be reversed.

Operations of block 740 can also include determining a type of a material for the SCL to be deposited and a thickness d of the SCL. In some embodiments, this determination can be made based on multiple expansion coefficients (more than just the paraboloid bow coefficient A₄) from the set {Aⱼ} or the full profile h(r, ϕ). In one specific non-limiting example, the thickness d can be determined as follows. First, a target paraboloid deformation Ã₄ can be determined that is sufficient to overcompensate for the measured substrate deformation, e.g., for h(r, ϕ)<0, the following condition can be satisfied:

$${\tilde{A}}_{4} {Z}_{4} ( ρ , ϕ ) + h ( r , ϕ ) ≡ ( {\tilde{A}}_{4} + {A}_{4} ) {Z}_{4} ( ρ , ϕ ) + {A}_{5} {Z}_{5} ( ρ , ϕ ) + {A}_{5} {Z}_{6} ( ρ , ϕ ) + … > 0.$$

In other words, the target paraboloid deformation Ã₄ can be chosen sufficiently large to compensate for the paraboloid deformation (A₄), saddle deformation (A₅ and A₆) and the residual deformation (A₇, and higher coefficients). In some embodiments, the target paraboloid deformation Ã₄ can be selected with at least an excess magnitude A_{E} over the minimum needed to overcompensate for the substrate deformation, e.g.,

$${\tilde{A}}_{4} {Z}_{4} ( ρ , ϕ ) + h ( r , ϕ ) > {A}_{E} {Z}_{4} ( ρ , ϕ ) .$$

The excess magnitude A_{E} can be empirically selected and can depend on the specific material used for the SCL.

Once the target paraboloid deformation Ã₄ has been determined, the thickness d of the SCL can be selected using a calibration data that tabulates or otherwise defines a function d=f(Ã₄). In some embodiments, the function ƒ(Ã₄) can be a non-linear function. In some embodiments, the function ƒ(Ã₄) can be a linear function, d=αÃ₄, with a coefficient of proportionality a determined based on mathematical modeling of elastic equations for specific SCL material(s), using empirical calibration, or any combination thereof. In some embodiments, thickness d of the SCL is selected to make deformation h_{corr}(r, ϕ) of a uniaxial type (e.g., cylindrical) after SCL deposition.

At blocks 760-764, method 700 can include determining (e.g., computing) a local irradiation dose map n(x, y) for irradiation of the SCL with a stress-modification beam. The stress-modification beam can include ions, photons, electrons, and/or any combination thereof. In some embodiments, the dose map n(x, y) can be determined using an MLM. In some embodiments, the dose map n(x, y) can be determined using a combination of an MLM and a physics-based model, e.g., a model that solves the elastic plate equation for a substrate (e.g., using a finite difference method or other techniques of solving partial differential equations) and further models how stresses in the SCL are mitigated by received doses of the particles (or photons) of the beam.

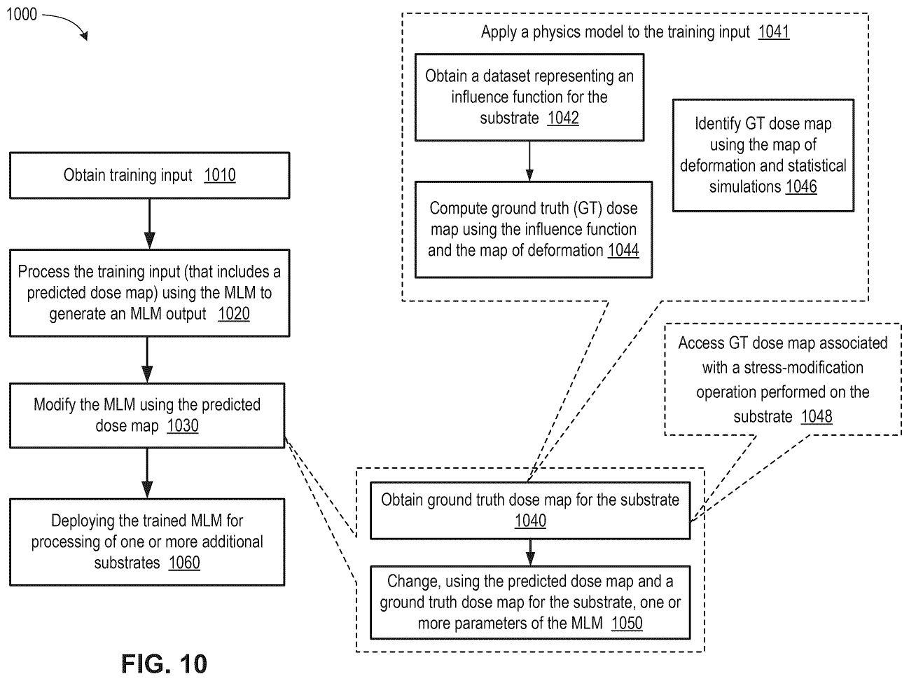

More specifically, at block 760, method 700 can include obtaining an input into the MLM, the input including a map of deformation of the substrate, and processing, using the MLM, the obtained input to generate an MLM output. The MLM output can include a first dose map for a stress-modification beam (SMB). In some embodiments, the input can include one or more parameters of the SCL formed on the substrate. The one or more parameters of the SCL can include a material of the SCL, a thickness of the SCL, a level of stress of the SCL, and/or the like. In some embodiments, the input can further include one or more settings of the SMB, e.g., a type of particles of the SMB, an energy of the particles of the SMB, one or more geometric characteristics of the SMB (e.g., width of the SMB along one or more spatial dimensions, shape of the SMB, and/or the like), and so on. In some embodiments, training the MLM can be performed as disclosed below in conjunction with FIG. 10.

In some embodiments, the one or more parameters of the SCL and/or the one or more settings of the SMB are not included in the input into the MLM but instead are computed by the MLM and obtained as part of the MLM output.

At block 762, operations of method 700 can include applying a physics-based model to the input to obtain a second dose map for the SMB. In such embodiments, as illustrated with block 764, the dose map imparted to the SCL can include the first dose map weighted with a first weight and the second dose map weighted with a second weight. In some embodiments, the first weight increases with an amount of training of the MLM and the second weight decreases with the amount of training of the MLM.

In some embodiments, applying the physics-based model can include obtaining a dataset with a representation of an influence function for the substrate. The influence function can characterize a deformation response of the substrate caused by a point-like mechanical influence. Applying the physics-based model can further include computing the second dose map using the representation of the influence function and the map of deformation of the substrate.

In some embodiments, applying the physics-based model can include identifying, using the map of deformation of the substrate and a plurality of statistical simulations, the second dose map. Performing the plurality of statistical simulations can include sampling from one or more statistical distributions associated with previously performed stress modifications.

At block 770, method 700 can continue with depositing or otherwise forming a stress-compensation layer (SCL) on the substrate. In some embodiments, the SCL can have a uniform thickness and can be selected at block 740. In some embodiments, the thickness of the SCL can be generated by the MLM (at block 760). In some embodiments, SCL can be deposited on the back side of the substrate. In some embodiments, the SCL can be deposited on the front side of the substrate. In some embodiments, at least some operations of block 770 can be performed prior to operations of blocks 750 and 760 (e.g., forming the SCL on substrate). In some embodiments, operations of block 770 can include forming a spatially non-uniform protective mask on the SCL. A profile of the protective mask can be based on the first dose map (predicted by the MLM) and/or the second dose map (predicted by the physics-based model). The protective mask can be computed to facilitate delivery of the computed non-uniform dose map to the SCL. For example, delivery of large-scale (substrate-scale) doses to SCL can be controlled by the profile of the protective mask, by varying the peak flux j₀ of the beam, spatial dimensions of the beam, local scanning velocity of the beam, and/or the like. Increasing (decreasing) trench width of the protective mask for a given period and pattern thickness can result in decreased/increased stiffness of the SCL (e.g., in the direction perpendicular to the axis of the pattern), since the size of the protected areas in the SCL is decreased/increased. Similarly, decreased or increased stiffness of the SCL can be achieved by decreasing or increasing pattern thickness for given period and trench width. Increasing resolution by decreasing period (for a given aspect ratio of the width to the period) can result in a more uniform stress mitigation whereas increasing period can facilitate stress modulations of higher amplitude (e.g., larger difference between the maximum and minimum stress).

Forming the SCL mask can be performed by spin coating a photoresist, optical photolithography, imprint lithography, developing the photoresist, and/or other suitable techniques. In some embodiments, digital lithography techniques can be used instead of (or in addition to) contact printing. Optical lithography can include (but need not be limited to) contact photolithography (e.g., with a photoresist making a direct contact with the substrate), proximity photolithography (e.g., with a photoresist separated by a small gap from the substrate), and/or projection photolithography (e.g., with an optical element, such as a lens, positioned within the gap between the photoresist and the substrate).

At block 780, method 700 can continue with subjecting the SCL and/or the SCL mask to a stress-modification beam to cause mitigation of the deformation of the substrate, e.g., to reduce the amount of stress in the substrate/films/mask structure and flatten this structure. In some embodiments, application of the stress-modification beam can be performed with locally-changing beam parameters, e.g., scanning velocity, lateral beam dimensions, flux of the particles in the beam, and/or the like.

At block 790, method 700 can include re-measuring the shape of the substrate after application of the SMB to evaluate effectiveness of the MLM output in mitigation of substrate deformation. In those embodiments where method 700 deploys a combination (hybrid) of the MLM and a physics-based model, at block 792, the relative weights with which the outputs of the two models enter the final dose maps are used in the can be updated.

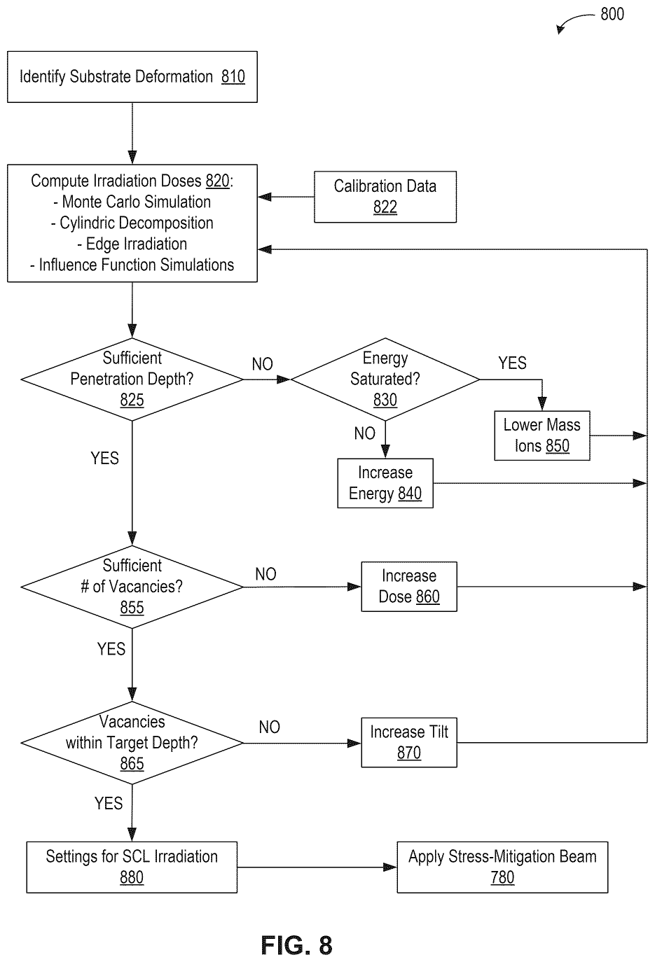

FIG. 8 is a flowchart illustrating an example method 800 of determining settings for beam irradiation, according to at least one embodiment. Method 800 can be performed, e.g., as part of determining ground truth for training of the MLM as part of method 1000, as disclosed in conjunction with of FIG. 10. At block 810, method 800 can include identifying some or all of a parabolic deformation (e.g., Zernike coefficients A₄), saddle deformation (e.g., Zernike coefficients A₅, A₆), and the residual deformation (e.g., Zernike coefficients A₇, A₈ . . . ) of a substrate, e.g., using profilometry measurements. (Operations of block 810 can be performed as part of block 730 of method 700).

At block 820, method 800 can continue with computing irradiation doses n(\vec{r}) for the SCL deposited on the substrate. (Operations of block 820 can be performed as part of block 760 of method 700). Operations of block 820 can be performed by a physics-based model (e.g., as part of operations of the hybrid model and/or as part of obtaining ground truth for training the MLM) and can include one or more techniques for determining n(\vec{r}). In some embodiments, irradiation doses n(\vec{r}) can be computed using Monte Carlo simulations. In some embodiments, irradiation doses n(\vec{r}) can be computed using cylindrical decomposition of h_{WF}(\vec{r}), e.g., a decomposition of a saddle shape deformation into a parabolic deformation and a cylindrical deformation.

In some embodiments, irradiation doses n(\vec{r}) can be computed (and then applied at block 780) for selected edge regions of the SCL. For example, if the axis of cylindrical deformation, is the y-axis (as in FIG. 1B), the edge regions can be regions located within some vicinity of points x=±R, y=0, where R is the radius of the substrate. Irradiation doses n(\vec{r}) near other regions (e.g., near the center of the substrate) can be significantly lower and/or zero, in some embodiments. In some embodiments, the edge regions of the SCL have a width that is at or below 30% of a diameter of the substrate. In some embodiments, the edge regions of the SCL can be exposed to a spatially uniform dose of particles of the stress-modification beam, a radially-varying dose of particles of the stress-modification beam, or an azimuthally-varying dose of particles of the stress-modification beam. In some embodiments, irradiation doses n(\vec{r}) can be spread out more uniformly across the area of the substrate, e.g., can be non-zero both near the edges and near the middle of the substrate. In some embodiments, irradiation doses n(\vec{r}) can be uniform (constant) throughout the area of the substrate while the uniformity of stress-modification is achieved by the deposited protective pattern having spatially-varying parameters (e.g., width W, period P, thickness T, etc.).

In some embodiments, irradiation doses n(\vec{r}) can be computed using an influence function G(\vec{r}; \vec{r}′), also known as the Green's function, which characterizes a response (e.g., deformation) of the substrate at a point r of the substrate as caused by a point-like force applied at a point \vec{r}′ of the substrate. In some embodiments, the influence function G(\vec{r}; \vec{r}′) can be determined from computational simulations or analytical calculations. In some embodiments, the influence function can be determined from one or more experiments, which can include performing ion implantation into a film deposited on a reference substrate. In some embodiments, a combination of multiple techniques of determining the influence function G(\vec{r}; \vec{r}′) can be used.

As a way of example, the Monte Carlo simulations for a structure (e.g., substrate with films and an SCL deposited thereon) can be performed for specific materials of the structure (e.g., silicon substrate, stack of films, and/or the like) and for a specific thickness of the structure. An initial Monte Carlo simulation can be performed for baseline (default) conditions of beam irradiation (e.g., default settings of an ion implantation apparatus or a light-emitting apparatus). The baseline conditions can include a default type of particles (ions, photons, electrons), a default energy of particles, a default dose of particles to be directed to the SCL (e.g., a default velocity of scanning and a default scanning pattern), and the like.

In some embodiments, various techniques of irradiation dose computations can use calibration data 822 collected for actual irradiation performed for various types of the irradiation beams, energies of the irradiation beams, types and materials of structures being irradiated, angles of beam incidence on the structures, and/or the like. In some embodiments, calibration data 822 can be statistically preprocessed. For example, various measurements can be collected for multiple substrate/films/SCL materials, types of particles, angles of incidence, and/or other parameters. The statistically processed measurements can be stored (e.g., in a memory of a processing device performing computation of the irradiation doses) in the form of probability distributions of various quantities, including but not limited to:
distribution of the density of ion implantation with depth for different ion types, ion energies, angles of incidence;
distribution of the number of vacancies produced at different depths (per unit of length of travel of the ions) for different types of irradiation particles (ions, photons, electrons), particle energies, and angles of incidence;
distribution of stresses created by irradiation beams for different beam intensities and durations; and/or the like.

Performing irradiation dose computations of block 820 can include sampling from the stored distributions and identifying a likelihood that a target stress mitigation will be achieved with the default settings of conditions of beam irradiation of a SCL of a given type and thickness. Method 800 can include several verification operations designed to determine whether the target stress can be achieved without detrimentally affecting properties of the substrate/films. For example, at block 825, method 800 can include verifying if the penetration depth of the selected (e.g., default) type of particles is sufficient. For example, the penetration depth is to be at least a certain fraction of the thickness of the SCL, e.g., 20%, 30%, 50%, 80%, or more of that thickness. In some embodiments the penetration depth can be up to 100% of the thickness. If the energy is insufficient, method 800 can include checking, at block 830, if the irradiation beam source is capable of outputting particles of a higher energy. If higher energies are available, method 800 can continue with increasing the energy of the particles (block 840) and repeating irradiation dose computations of block 820 for the increased energy. If the maximum energy of the irradiation beam source has already been reached, method 800 can continue with replacing (at block 850) ions with ions of a different type (e.g., if an ion beam is used for irradiation), e.g., replacing Silicon ions with Boron, Carbon, Fluorine, etc., ions, and repeating Monte Carlo simulations for the ions of the new type.

At block 855, method 800 can include verifying whether the number of expected formed vacancies is sufficient. To verify sufficiency, method 800 can assess stress mitigation caused by formed vacancies. In one embodiment, method 800 can begin at some value of stress in the SCL, e.g., −3.0 GPa or some other suitable value (negative sign indicating compressive stress) and use beam irradiation to mitigate this stress towards a neutral point, 0.0 GPa at various locales of the SCL.

If the number of vacancies is insufficient, method 800 can include increasing a dose of particles (at block 860) and repeating irradiation dose computations of block 820 for the increased dose.

At block 865, method 800 can include verifying that the vacancies are going to be placed within a target depth, e.g., the thickness d of the film or a certain fraction of the film, such as 0.8 d, 0.7 d, 0.5 d, or some other value empirically set to prevent particles from penetrating into the substrate/films and affecting properties of the substrate/films. If the vacancies are to be formed at depths that exceed the target depth, method 800 can include (at block 870) increasing an angle of incidence (e.g., by tilting the irradiation beam) to keep vacancies (as well as substitution impurities) to a shallower region of the SCL.

Blocks 820-870 can be repeated multiple times until irradiation dose computations of block 820 are determined to be sufficient that the desired stress mitigation can be achieved, e.g., that the reduction in the tensile stress of the SCL is such that the deformation of the substrate is eliminated or at least reduced to an acceptable tolerance. The final settings for SCL irradiation (block 880) determined from irradiation dose computations can then be used for irradiation of the SCL with the stress-modification beam (at block 780).

FIG. 9A illustrates schematically an irradiation system 900 capable of performing irradiation of stress compensation layers, according to at least one embodiment. Irradiation system 900 can include collimating and focusing column 220 of FIG. 2B. Irradiation system 900 can further include a beam source 902 for producing a source beam 904. Beam source 902 can include a chamber for generating ions (e.g., a plasma chamber), a light source for generating photons (e.g., a laser, laser diode, lamp, etc.), a heated filament for producing electrons, and/or any other source for the particles of a type deployed in specific stress-modification techniques of the instant disclosure. Beam source 902 can be powered by a power element 906 and can include an extraction electrode assembly (not shown). Irradiation system 900 can include a mass spectrometer 908 (e.g., in the instances where beam source 902 produces charged particles, such as electrons or ions) and a collimating and focusing column 220. Collimating and focusing column 220 can direct stress-modification beam 218 to the substrate, e.g., wafer 202. Wafer 202 can be supported by a support stage 912. In some embodiments, support stage 912 and wafer 202 can remain stationary during irradiation of wafer 202 by stress-modification beam 218 while components of irradiation system 900 can be repositioned relative to wafer 202. In some embodiments, irradiation system 900 can be stationary while support stage 912 can reposition wafer 202. In some embodiments, stress-modification beam 218 can have intensity (e.g., light intensity) that is modulated by changing intensity of beam source 902 and/or placing a partially absorbing or partially reflecting material at some location between beam source 902 and wafer 202. This enables delivery of local irradiation doses n(x, y) to various locations of wafer 202. Scanning with stress-modification beam 218 can occur along multiple directions, e.g., along x-axis and along y-axis according to any suitable predetermined pattern, e.g., back- and forth along x-axis, in a spiral pattern, and so on. In various embodiments, stress-modification beam 218 can be scanned with a frequency of several Hz, tens of Hz, hundreds of Hz, thousands of Hz, or more.

Operations of irradiation system 900 can be controlled by a controller 914, which can include any suitable computing device, microcontroller, or any other processing device having a processor, e.g., a central processing unit (CPU), a field-programmable gate array (FPGA), an application-specific integrated circuit (ASIC), and/or the like, and a memory device, e.g., a random-access memory (RAM), read-only memory (ROM), flash memory, and/or the like or any combination thereof. Controller 914 can be or include any suitable computing device that can control operations of power element 906, support stage 912, and/or various other components and modules of irradiation system 900. Controller 914 can include a stress-modification module 916 capable of performing simulations that determine a target intensity of stress-modification beam 218 to be used to mitigate various substrate deformations. Stress-modification module 916 can deploy stress-modification MLM 410 and/or physics-based model 620, operating (and trained) as disclosed above. In some embodiments, as illustrated in FIG. 9B, support stage 912 can impart a tilt, e.g., in one or two spatial directions to wafer 202 to change an angle of incidence of stress-modification beam 218 relative to wafer 202. In some embodiments, instead of tilting wafer 202, controller 914 can cause a tilt of stress-modification beam 218 relative to wafer 202.

FIG. 10 is a flowchart illustrating an example method 1000 of training a machine learning model to facilitate mitigation of stresses in substrate in manufacturing of semiconductor devices and/or other applications, according to at least one embodiment. Method 1000 may be performed by a suitable processing device communicatively coupled to a memory device. The memory device can be any suitable non-transitory computer-readable storage medium storing instructions to perform operations of method 1000.

At block 1010, method 1000 includes obtaining a training input. The training input can include a representation of deformation of a substrate. The representation of deformation can include a first map of deformation of the substrate prior to application of a stress-modification beam (SMB) and can further include a second map of deformation of the substrate after application of the SMB. In some embodiments, the training input can further include one or more parameters of the SCL formed on the substrate. The one or more parameters can include a material of the SCL, a thickness of the SCL, a level of stress of the SCL, and/or the like. In some embodiments, the training input further includes one or more settings of the SMB, e.g., a type of particles of the SMB, an energy of the particles of the SMB, one or more geometric characteristics of the SMB, and/or the like.

At block 1020, method 1000 can include processing the training input using the MLM to generate an MLM output. The MLM output can include a predicted dose map for the SMB that, being applied to the SCL formed on the substrate, causes modification of the deformation of the substrate. In some embodiments, the MLM output can include one or more parameters of the SCL and/or one or more settings of the SMB.

At block 1030, method 1000 can include modifying the MLM using at least the predicted dose map. In some embodiments, operations of block 1030 can include any, some, or all operations illustrated with the callout blocks of FIG. 10. For example, at block 1040, modifying the MLM can include obtaining a ground truth dose map for the substrate. In some embodiments, as illustrated with block 1041, the ground truth dose map is obtained by applying a physics model to the training input. In some embodiments, applying the physics model to the training input can include, as illustrated with block 1042, obtaining a dataset representing an influence function for the substrate. The influence function can characterize a deformation response of the substrate caused by a point-like mechanical influence. At block 1044, applying the physics model can further include computing the ground truth dose map using the influence function and the map of deformation of the substrate.

In some embodiments, as illustrated with block 1046, applying the physics model can include identifying, using the map of deformation of the substrate and a plurality of statistical simulations, the ground truth dose map, wherein the plurality of statistical simulations comprises sampling from one or more statistical distributions associated with previously performed stress modifications.

In some embodiments, at block 1048, obtaining the ground truth dose map can include accessing the ground truth dose map associated with a stress-modification operation previously performed on the substrate.

At block 1050, method 1000 can include changing, using the predicted dose map and a ground truth dose map for the substrate, one or more parameters of the MLM.

At block 1060, method 1000 can include causing the trained MLM to be deployed for processing of one or more additional substrates.

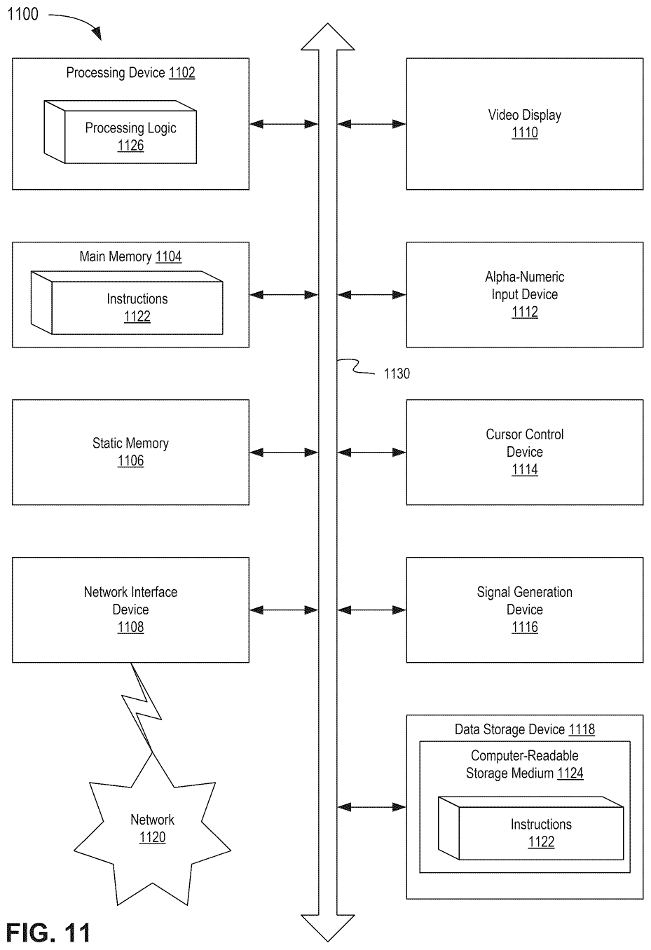

FIG. 11 depicts a block diagram of an example computer system 1100 capable of supporting operations of the present disclosure, according to at least one embodiment. In various illustrative examples, example computer system 1100 can be or include controller 914 of FIG. 9. Example computer system 1100 can be connected to other computer systems in a LAN, an intranet, an extranet, and/or the Internet. Computer system 1100 can operate in the capacity of a server in a client-server network environment. Computer system 1100 can be a personal computer (PC), a set-top box (STB), a server, a network router, switch or bridge, or any device capable of executing a set of instructions (sequential or otherwise) that specify actions to be taken by that device. Further, while only a single example computer system is illustrated, the term “computer” shall also be taken to include any collection of computers that individually or jointly execute a set (or multiple sets) of instructions to perform any one or more of the methods discussed herein.

Example computer system 1100 can include a processing device 1102 (also referred to as a processor or CPU), a main memory 1104 (e.g., read-only memory (ROM), flash memory, dynamic random access memory (DRAM) such as synchronous DRAM (SDRAM), etc.), a static memory 1106 (e.g., flash memory, static random access memory (SRAM), etc.), and a secondary memory (e.g., a data storage device 1118), which can communicate with each other via a bus 1130.

Processing device 1102 represents one or more general-purpose processing devices such as a microprocessor, central processing unit, or the like. More particularly, processing device 1102 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1102 can also be one or more special-purpose processing devices such as an application specific integrated circuit (ASIC), a field programmable gate array (FPGA), a digital signal processor (DSP), network processor, or the like. In accordance with one or more aspects of the present disclosure, processing device 1102 can include a processing logic 1126 configured to execute instructions (e.g., instructions 1122) implementing example method 700 of using a machine learning model to facilitate mitigation of stresses in wafers, example method 800 of determining settings for beam irradiation, and/or example method 1000 of training a machine learning model to facilitate mitigation of stresses in substrate in manufacturing of semiconductor devices and/or other applications.

Example computer system 1100 can further comprise a network interface device 1108, which can be communicatively coupled to a network 1120. Example computer system 1100 can further comprise a video display 1110 (e.g., a liquid crystal display (LCD), a touch screen, or a cathode ray tube (CRT)), an alphanumeric input device 1112 (e.g., a keyboard), a cursor control device 1114 (e.g., a mouse), and an acoustic signal generation device 1116 (e.g., a speaker).

Data storage device 1118 can include a computer-readable storage medium (or, more specifically, a non-transitory computer-readable storage medium) 1124 on which is stored one or more sets of executable instructions 1122. In accordance with one or more aspects of the present disclosure, executable instructions 1122 can comprise executable instructions implementing example method 700 of using a machine learning model to facilitate mitigation of stresses in wafers, example method 800 of determining settings for beam irradiation, and/or example method 1000 of training a machine learning model to facilitate mitigation of stresses in substrate in manufacturing of semiconductor devices and/or other applications.

Executable instructions 1122 can also reside, completely or at least partially, within main memory 1104 and/or within processing device 1102 during execution thereof by example computer system 1100, main memory 1104 and processing device 1102 also constituting computer-readable storage media. Executable instructions 1122 can further be transmitted or received over a network via network interface device 1108.

While the computer-readable storage medium 1124 is shown in FIG. 11 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems can be used with programs in accordance with the teachings herein, or it can prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other embodiment examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A method of training a machine learning model (MLM), the method comprising:
generating a training input comprising:
a representation of deformation of a substrate;
processing the training input using the MLM to generate an MLM output, wherein the MLM output comprises a predicted dose map for a stress-modification beam (SMB), wherein the SMB, being applied to a stress-compensation layer (SCL) formed on the substrate, causes modification of the deformation of the substrate;
modifying the MLM using at least the predicted dose map; and
causing the trained MLM to be deployed for processing of one or more additional substrates.

2. The method of claim 1, wherein the representation of deformation is based on:
a first map of deformation of the substrate prior to application of the SMB, and
a second map of deformation of the substrate after application of the SMB.

3. The method of claim 1, wherein modifying the MLM comprises:
changing, using the predicted dose map and a ground truth dose map for the substrate, one or more parameters of the MLM.

4. The method of claim 3, wherein the ground truth dose map is obtained by at least one of:
applying a physics model to the training input; or
accessing the ground truth dose map associated with a stress-modification operation performed on the substrate.

5. The method of claim 4, wherein applying the physics model to the training input comprises:
obtaining a dataset representing an influence function for the substrate, the influence function characterizing a deformation response of the substrate caused by a point-like mechanical influence; and
computing the ground truth dose map using the influence function and the map of deformation of the substrate.

6. The method of claim 4, wherein applying the physics model comprises:
identifying, using the map of deformation of the substrate and a plurality of statistical simulations, the ground truth dose map, wherein the plurality of statistical simulations comprises sampling from one or more statistical distributions associated with previously performed stress modifications.

7. The method of claim 1, wherein the training input further comprises:
one or more parameters of the SCL formed on the substrate, wherein the one or more parameters of the SCL comprise at least one of:
a material of the SCL,
a thickness of the SCL, or
a level of stress of the SCL.

8. The method of claim 1, wherein the training input further comprises one or more settings of the SMB, wherein the one or more settings of the SMB comprise at least one of:
a type of particles of the SMB,
an energy of the particles of the SMB, or
one or more geometric characteristics of the SMB.

9. The method of claim 1, wherein the MLM output further comprises at least one of:
one or more parameters of the SCL, or
one or more settings of the SMB.

10. A method comprising:
obtaining an input into a machine learning model (MLM), wherein the input comprises a map of deformation of a substrate;
forming a stress-compensation layer (SCL) on the substrate;
processing, using the MLM, the obtained input to generate an MLM output, wherein the MLM output comprises:
a first dose map for a stress-modification beam (SMB); and
subjecting the SCL to the SMB to cause modification of the deformation of the substrate, wherein a dose map imparted to the SCL is based at least on the first dose map.

11. The method of claim 10, wherein the input further comprises:
one or more parameters of the SCL formed on the substrate, wherein the one or more parameters of the SCL comprise at least one of:
a material of the SCL,
a thickness of the SCL, or
a level of stress of the SCL.

12. The method of claim 10, wherein the input further comprises one or more settings of the SMB, wherein the one or more settings of the SMB comprise at least one of:
a type of particles of the SMB,
an energy of the particles of the SMB, or
one or more geometric characteristics of the SMB.

13. The method of claim 10, wherein the MLM output further comprises at least one of:
one or more parameters of the SCL, or
one or more settings of the SMB.

14. The method of claim 10, further comprising:
applying a physics-based model to the input to obtain a second dose map for the SMB, wherein the dose map imparted to the SCL is further based at the second dose map.

15. The method of claim 14, wherein the dose map imparted to the SCL comprises:
the first dose map weighted with a first weight, and
the second dose map weighted with a second weight.

16. The method of claim 15, where the first weight increases with an amount of training of the MLM and the second weight decreases with the amount of training of the MLM.

17. The method of claim 14, wherein applying the physics-based model comprises:
obtaining a dataset comprising a representation of an influence function for the substrate, wherein the influence function characterizes a deformation response of the substrate caused by a point-like mechanical influence; and
computing the second dose map using the representation of the influence function and the map of deformation of the substrate.

18. The method of claim 14, wherein applying the physics-based model comprises:
identifying, using the map of deformation of the substrate and a plurality of statistical simulations, the second dose map, wherein performing the plurality of statistical simulations comprises sampling from one or more statistical distributions associated with previously performed stress modifications.

19. The method of claim 10, further comprising:
forming a spatially non-uniform protective mask on the SCL, the protective mask having a profile that is based at least on the first dose map, and wherein the dose map imparted to the SCL is determined, at least in part, by the protective mask.

20. A system comprising:
a memory; and
a processing device communicatively coupled to the memory, wherein the processing device causes performance of operations comprising:
obtaining a training input comprising:
a map of deformation of a substrate;
processing the training input using a machine learning model (MLM) to generate an MLM output, wherein the MLM output comprises a predicted dose map for a stress-modification beam (SMB), wherein the SMB, being applied to a stress-compensation layer (SCL) formed on the substrate, causes modification of the deformation of the substrate;
modifying the MLM using at least the predicted dose map; and
causing the trained MLM to be deployed for processing of one or more additional substrates.
